(19) United States
(12) Patent Application Publication
(10) Pub. No.: US 2012/0036021 A1
(43) Pub. Date: Feb. 9, 2012

(54) SYSTEM AND METHOD OF DELIVERING ADVERTISMENTS AS RINGBACK TONES

(76) Inventor: MARCUS HUDDLESTON, Southfield, MI (US)

(21) Appl. No.: 12/851,388

(22) Filed: Aug. 5, 2010

(51) Int. Cl. G06Q 30/00; H04M 3/42

(52) U.S. Cl. 705/14.69; 379/207.16; 705/14.4

(57) ABSTRACT

A system and method of delivering an advertisement as a ringback tones (RBT) for telephone, mobile phone, or voice over internet protocol (VOIP) systems may include providing data exchanging means between a telephone exchange system or a mobile switching center through use of an web service coded in extendable markup language (XML), simple object access protocol (SOAP), or binary data for playing of the advertisement as ringback tones, reconciliation against an advertising campaign, and payment to subscribers of the advertisement as ringback tones. A subscriber may sign up for delivery of the advertisement as ringback tones, may choose one or more types of the advertisement as a ringback tone, and may place and enable the one or more types of the advertisement as a ringback tone in a jukebox or a playback lineup. The subscriber can store any of the advertisements as ringback tones, whereby calling parties placing calls to the subscriber hear the advertisements as a ringback tone.

### BACKGROUND OF THE INVENTION

The present invention generally relates to delivering ringback tones, more specifically, to systems and methods of delivering advertisements as ringback tones through telephone, mobile phone, and VOIP systems.

### SUMMARY OF THE INVENTION

In one aspect of the present invention, a system for delivering an advertisement as a ringback tone to a calling party comprises a telephone exchange system or a mobile switching center receiving a call initiated by the calling party; a ringback system for providing the advertisement as the ringback tone to the calling party via the telephone exchange system of the mobile switching center; a content management server for retrieving stored advertisement ringbacks and providing the advertisement ringbacks to a web service; and an advertising management server for receiving advertisements from advertisers and for collecting advertisement data.

In another aspect of the present invention, a method of delivering an advertisement as a ringback tones for a telephone, a mobile phone, or a voice over internet protocol (VOIP) system comprises providing data exchanging means with a telephone exchange system or a mobile switching center for playing the advertisement as ringback tones; signing up a subscriber for delivery of the advertisement as ringback tones; choosing one or more types of the advertisement as the ringback tone; enabling the one or more types of the advertisement as the ringback tone, wherein the subscriber can store any of the advertisements as ringback tones, and wherein calling parties placing calls to the subscriber hear the advertisements as ringback tones.

These and other features, aspects and advantages of the present invention will become better understood with reference to the following drawings, description and claims.

### BRIEF DESCRIPTION OF THE DRAWINGS

FIGS. 1 through 3 show an interconnected flow chart describing a method according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally includes a system and method of delivering advertisement as a ringback tones (RBT) for telephone, mobile phone, or voice over internet protocol (VOIP) systems. Methods of the present invention may include providing data exchanging means between a telephone exchange system or a mobile switching center through use of an web service coded in extendable markup language (XML), simple object access protocol (SOAP), or binary data for playing of the advertisement as ringback tones, reconciliation against an advertising campaign, and payment to subscribers of the advertisement as ringback tones. A subscriber may sign up for delivery of the advertisement as ringback tones, may choose one or more types of the advertisement as a ringback tone, and may place and enable the one or more types of the advertisement as a ringback tone in a jukebox or a playback lineup. The subscriber can store any of the advertisements as ringback tones, whereby calling parties placing calls to the subscriber hear the advertisements as a ringback tone.

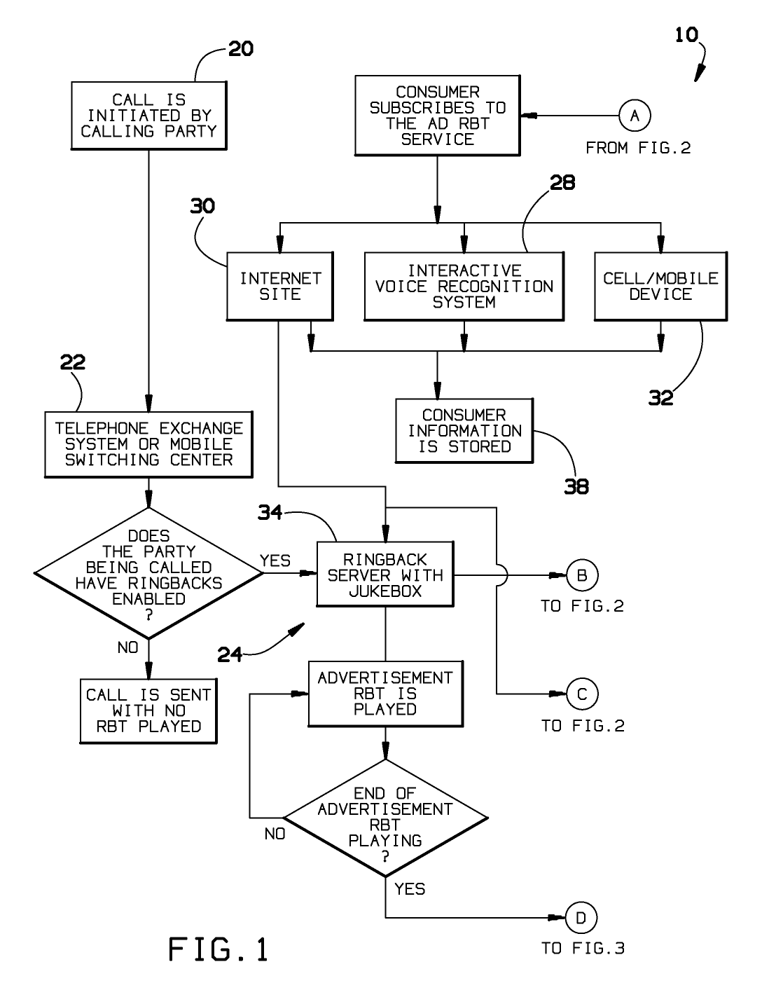

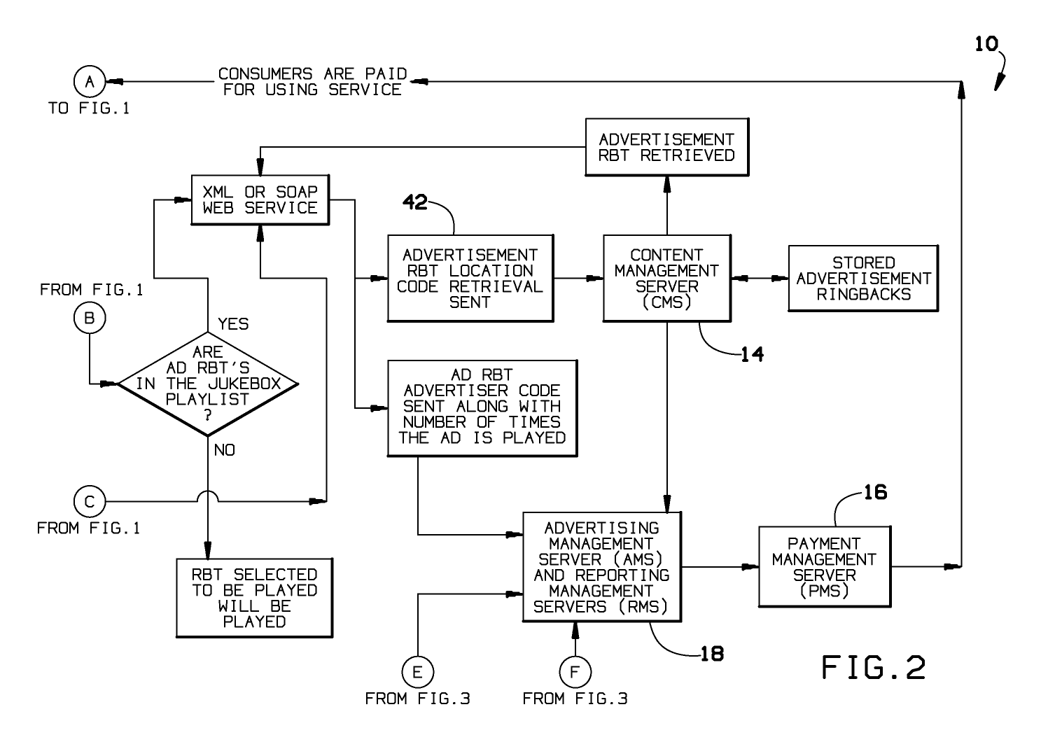

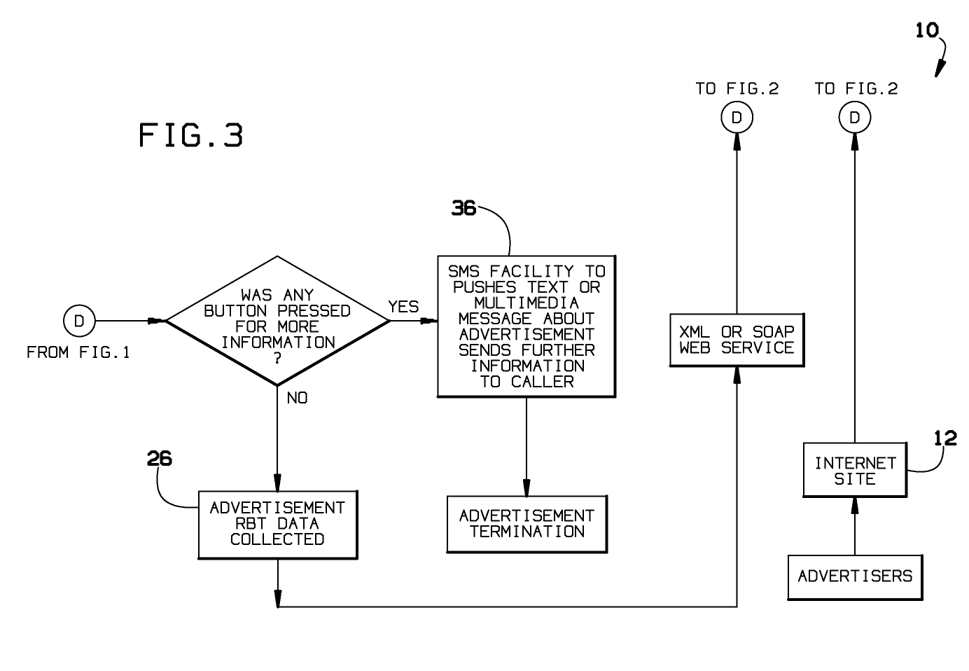

Referring to FIGS. 1 through 3, an advertising network 10 may include the following components: a web site 12, a content management system (CMS) 14, a payment management system 16 (PMS), and an advertisement management system 18 (AMS). The advertisement network may integrate into any existing service provider with any one of the following exemplary networks: Global System for Mobile communications (GSM), W-CDMA/UMTS, CDMA2000®, cdmaOne™, VOIP, WIMAX, and wire line networks.

The systems and methods of the present invention may be practiced according to an exemplary embodiment as follows.

The method to send advertisement RBT's may be purely dependent on the choice of telephone/mobile phone subscriber to opt-in to advertisement RBT's. The calling party may receive the advertisement RBT once a call is initiated (step 20) and they connect via a telephone exchange system or a mobile switching center 22. The advertisement RBT may be played before the receiving person answers the calling party's call. When a subscriber to a RBT service wants to play advertisements they may select them as they would normally select any RBT. Advertisement RBT's may be provided to the users of the requested advertisement RBT by request made from the RBT system to the advertisement management network and/or content management system. Subscribers to an RBT service also have the ability to request their advertisement RBT through an interactive voice response (IVR) system which sends a request to an advertisement management or content management system for the advertisement RBT. For using advertisement RBT's the subscriber may receive monetary payments for opting in and placing the advertisements on their telephone/mobile phone. Through the use of the “Get more information” option the calling party can receive more detailed information about the advertisement they listened to, such as discounts and/or other advertised incentives.

The system and method of providing advertisement RBT's to existing RBT systems according to embodiments of the invention may provide unique marketing opportunities for advertisers and may give RBT systems access to a wider variety of content. Through the use of modern web technology, advertisement RBT's location of where the advertisement RBT is stored on the content management system may be delivered through web services using XML, SOAP, or binary data. This may eliminate the need to store any files directly on an RBT system and allow for the advertisement RBT's to be delivered to any RBT system in an open source type of feel. If an RBT system wants to store the advertisement locally on their system, then a standard file transfer protocol can be used to transfer the advertisement RBT's. Once a subscriber to an advertisement RBT decides to utilize an advertisement RBT on their telephone/mobile phone, the advertisement network containing the advertisement RBT is sent a request to provide information as to where that RBT is stored and how to access it. This request may be made from a telephone exchange, Mobile Switching Center, and/or VOIP system.

Once the advertisement information is provided through the web service using XML, SOAP, or binary data, the RBT system may be able to provide and play the advertisement RBT for the subscribing consumer who, in turn, may receive a monetary incentive for using the advertisement RBT. This delivery method may reduce RBT deployment time and cost and advertisement deployment cost, increase consumer adoption and retention of any RBT service, and can help grow telecommunications and the economy.

When a subscriber to the advertisement RBT service wants to setup an advertisement RBT they may use the same process that they would normally use to play other RBT's. The web service 12, using XML, SOAP, or binary data, may transmit the advertisement RBT location from the content management system 14 to the RBT system 24 which may then be transmitted to the caller. Once the advertisement RBT is played, data may be collected 26 concerning it and this data may be sent back to the advertisement management system. The subscribers account may be updated for compensation, and the advertiser's advertisement campaign may be updated for campaign management and debiting from the budget used to run the advertisement. To subscribe to the advertisement RBT service, consumers may opt-in by signing up using the internet 30 or by using an interactive voice recognition 28 (IVR) system. Consumers may also opt-in to use their service providers 32 RBT service. The telephone exchange/mobile switching center 22 may handle all call requests while the RBT system 24 may handle the playing of any RBT no matter if they are music, speech, or advertisement related.

In the present invention, where an RBT jukebox 34 exists, subscribers are able to setup advertisement RBT's along with other RBT's to be played randomly. Sometimes a caller wants to find out more information about a particular advertisement. In this case the caller may dial a number and a more information request code may be sent via the web service and may activate the short messaging service (SMS) to send a text message 36 to the caller with more information about the advertisement RBT they heard. The telephone exchange/mobile switching center may receive this code from the caller then may send it to the web service which may pass it to the SMS server. This process may help to improve a marketing opportunity for advertisers and offers advertisers qualified leads. The advertisement request code and more information request code may be codes placed during the advertisement RBT process and can include pressing any key button or buttons on the telephone/mobile phone hand set.

Still referring to the Figures, the telecommunications subscriber(s) may use either an Internet web site 30, call the IVR system 28, or their cell/mobile device 32 to sign-up for the advertisement RBT service as well as the RBT Service. The information entered during the sign-up may be stored in the consumer storage database 38.

The ringback system 24 may determine how advertisement RBTs are setup for play. If there are not any advertisement RBTs setup to be played, the RBT system plays the RBT's setup to play for the subscribing RBT user. If there are advertisement RBTs setup to be played, the ringback system may make a call to the advertisement management network (AMN) using a web service coded in XML, SOAP, or binary data. This call may ask the content management system of the AMN for the location code 42 of the advertisement RBT, stores the actual advertisement RBTs, and are associated with the location code on the CMS. Once the Location Code of the advertisement RBT is retrieved and supplied back to the Web Service, the web service may supply the ringback system with the necessary information for the ringback system to locate, access, and play the advertisement RBT for the calling party. At the end of the advertisement RBT playing the ringback system may recognize if the calling party dials any button to request more information. If any button is pressed, then a short messaging system (SMS) may be used to send an SMS message to the calling party with more information about the advertisement. This could include a link in the SMS message which could be clicked to take the calling party to a mobile website offering more information, coupons, and/or discounts for the advertisement they heard during the playing of the advertisement RBT.

Advertisers may use the AMN to setup their advertisement campaigns through a website 12. This website 12 may allow full management of an advertisement RBT campaign where advertisers can upload their advertisement RBTs, set a budget, pay for that budget, and manage their campaign(s) 24/7.

Consumers can opt-in/subscribe to a RBT service and an advertisement RBT service. Using a ringback System they select and setup the advertisement RBT's they would like for their calling parties to hear when they are being called. Through the use of the advertisement management systems, each advertisement RBT may have target customer settings where the advertiser can choose to where the advertisement should be played and under what ringback selection category the advertisement should be stored under for selection by consumers. Advertisers may be presented with target marketing information about each service providers target market so they can better make a decision on what network to offer their advertisement.

The advertisers also follow a similar procedure registration as consumers using the system for the first time. The advertiser's company details are input and the system loads their advertisement RBT files. The advertiser has the ability to input information about their advertisement RBT for their advertisement campaign by which the advertisement RBT should be played and presented to consumers. This is known as the advertisement RBT profile. The advertisement RBT is uploaded to a staging area where it will be played and listened to by an official of the organization, making sure that the advertisement RBT does not contain any obscene or unlawful material. After clearance from the official, the advertisement RBT is added to the advertisement RBT database.

When the hardware, the advertisement RBT circuit, request for the advertisement to be played for a particular telephone user, the software selects and uses the location request code provided through the web service to locate, access, and allow for the advertisement RBT to be played. This information may be stored in the database of the ringback systems.

Advertisers can log into their account on the advertisement management system, see all the advertisement RBT's that have been played, and generate appropriate reports for their needs. Subscribers can log into a website and see the advertisement RBT's that have been heard so far and the rewards they have received as a result of the advertisement RBT's played.

It should be understood, of course, that the foregoing relates to exemplary embodiments of the invention and that modifications may be made without departing from the spirit and scope of the invention as set forth in the following claims.

What is claimed is:

1. A method of delivering an advertisement as a ringback tones for a telephone, a mobile phone, or a voice over internet protocol (VOIP) system, the method comprising:
providing data exchanging means with a telephone exchange system or a mobile switching center for playing the advertisement as ringback tones;
signing up a subscriber for delivery of the advertisement as ringback tones;
choosing one or more types of the advertisement as the ringback tone;
enabling the one or more types of the advertisement as the ringback tone, wherein the subscriber can store any of the advertisements as ringback tones, and wherein calling parties placing calls to the subscriber hear the advertisements as ringback tones.

2. The method of claim 1, further comprising exchanging data with the telephone exchange system or the mobile switching center through use of an web service coded in XML, SOAP, or binary data for playing of the advertisement as ringback tones.

3. The method of claim 1 further comprising reconciling advertising data against an advertising campaign.

4. The method of claim 1, further comprising paying subscribers of the advertisement as ringback tones.

5. The method of claim 1, further comprising placing and enabling the one or more types of the advertisement as the ringback tone in a jukebox or a playback lineup.

6. The method of claim 1, further comprising providing additional information about the advertisement to the calling party if the calling party makes a request for additional information.

7. The method of claim 6, wherein the additional information is provided by a text message or a multimedia message pushed to the calling party.

8. A system for delivering an advertisement as a ringback tone to a calling party, the system comprising:
a telephone exchange system or a mobile switching center receiving a call initiated by the calling party;
a ringback system for providing the advertisement as the ringback tone to the calling party via the telephone exchange system of the mobile switching center;
a content management server for retrieving stored advertisement ringbacks and providing the advertisement ringbacks to a web service; and
an advertising management server for receiving advertisements from advertisers and for collecting advertisement data.

9. The system of claim 8, further comprising a payment management server for providing payment to consumers for using the system.

10. The system of claim 8, wherein the web service is coded in XML, SOAP, or binary data.
